(19) United States
(12) Patent Application Publication
(10) Pub. No.: US 2020/0222874 A1
(43) Pub. Date: Jul. 16, 2020

(54) VERSATILE PLANTS FOR CONVERTING BIOGAS INTO HIGH ADDED VALUE CHEMICALS

(71) Applicant: Politecnico di Milano, Milano (MI) (IT)

(72) Inventor: Flavio MANENTI, Milano (IT)

(21) Appl. No.: 16/627,003

(22) PCT Filed: Jul. 2, 2018
(86) PCT No.: PCT/IB2018/054895

§ 371 Date: Dec. 27, 2019

(30) Foreign Application Priority Data
Jun. 30, 2017 (IT) 102017000073797

(51) Int. Cl. B01J 19/00; B01J 19/24; C01B 3/48; C01B 3/56; H01M 8/0612; H01M 8/1231

(52) U.S. Cl. CPC B01J 19/004; H01M 2008/1293; B01J 19/0013; C01B 3/48; C01B 3/56; H01M 8/0618; H01M 8/1231; B01J 2219/0004; B01J 2208/00309; C01B 2203/0238; C01B 2203/0233; C01B 2203/0283; C01B 2203/1241; C01B 2203/107; C01B 2203/061; C01B 2203/066; C01B 2203/0822; C01B 2203/042; B01J 19/245

(57) ABSTRACT

Plant for the conversion of biogas into a chemical product with a high added value, selected among methanol, dimethyl ether, formaldehyde, acetic acid by a process comprising the following steps:
a) reforming by converting methane and carbon dioxide contained in the biogas into syngas,
b) synthesis of methanol by using syngas from step a),
b′) synthesis of one of the aforesaid chemical products: formaldehyde, dimethyl ether or acetic acid by using methanol from step b)
c) optional purification and separation of said chemical product,
characterized in that the reaction section in which the steps b) and b′) are carried out or a part of it is replaceable with a further and different whole section or section part, in order to obtain one of the aforesaid chemical products different from the one obtained before said substitution.

This plant can convert almost all or all the CO₂ produced in biogas plants into CO and subsequently into one or more chemical products with a high added value with revenues comparable to, if not higher than, those of traditional plants only obtainable thanks to incentives.

The plant is energy self-sustainable thanks to the use of its effluents for the production of energy and heat.

### FIELD OF THE INVENTION

The invention relates to a plant for converting biogas into chemical products with a high added value and related operating modes.

### STATE OF THE ART

Biogas is a gas that originates from fermentation/anaerobic digestion and is predominantly characterized by methane (CH₄) and carbon dioxide (CO₂). The ratio between CH₄ and CO₂ varies according to specific power supply (first generation biomass, recovery or second generation biomass, zootechnical waste such as sewage or pollen, or FORSU (Organic Fraction of Urban Solid Waste)), to seasonality, micro-organisms, operating conditions of digesters and plants, as well as according to ancillary units connected to the purification of biogas from any undesired compounds. The percentage of methane can generally vary from 55% by volume up to 80%, even if plants capable of supplying compositions out of this nominal range (20%-85%) are known.

Biogas in Italy is a well-established product with 1,823 operating plants, mainly concentrated in the Po Valley (about 450 plants in Lombardy alone), but it is even more so in Europe, with about 18,500 plants, more than half of which in Germany The most widespread plants of this type are those capable of generating electricity with a power in the order of 1 MW.

In fact, nowadays biogas is exclusively used to produce electricity and to supply it to the national power network after having used the electricity required for the management of the farm where it is installed. In order to generate electricity, the combustion engine burns biogas with air and at the same time generates heat that brings the combustion chamber to over 800° C.

The biogas plant is advantageous above all for the farms where it is installed, as well as for multi-utilities, due to the incentives received from the electricity supply companies.

In fact, an electric 1 MW plant that supplies, e.g., a biogas with 60% CH₄ and 40% CO₂ by volume, leads to a profit in electricity sold at a flat market price in Italy equal to 0.28€/kWh or 0.23€/kWh, depending on the year of installation. In the first case, the annual revenue is equal to 2.24 M€/year, in the second case (more recent biogas plants) it is equal to 1.84 M€/year.

Furthermore, biogas has significantly contributed to the achievement of European standards for renewable energy generation.

In environmental terms, it is a zero-impact process: the atmospheric CO₂ that has been fixed in the biomass is completely re-introduced into the atmosphere thanks to the combustion in the power generation engine. It is estimated that an electric 1 MW biogas plant reintroduces 7852 t/year of CO₂ into the atmosphere.

One of the most promising and discussed future potentials of biogas is its bio-methane purification (also called upgrading, according to the Bio-methane Decree of Mar. 2, 2018). Purification means the removal of the CO₂ present in the biogas in order to obtain a methane stream of renewable origin to be introduced into the gas network currently in use. This would solve the complex problem linked to the non-transportability of biogas (too expensive to be applied) thanks to the exploitation of the national gas network infrastructure. Purification technologies are the most varied. Among the most promising, there are absorption with water, amine softening systems, scrubber-type systems or membrane systems and intermittently operating zeolite filters. Each of the aforementioned systems has advantages and disadvantages, which are not relevant to the present patent.

Bio-methane purification is a less desirable solution than biogas. An electric 1 MW plant that supplies, by volume, a 60% CH₄ and 40% CO₂ biogas is equivalent, in mass, to 35% CH₄ and 65% CO₂. This inevitably leads to an exploitation of only ⅓ of the total biogas and, therefore, to a profit of 0.21 M€/year without incentives, which corresponds to an estimated methane value of 0.11€/kg. With the incentive defined in the Decree of Mar. 2, 2018, the revenue amounts to €1.35 million/y. Although interesting as a solution and as a prospect for this sector, it is less attractive for the farmer/breeder who runs the biogas plant, as well as being more invasive in terms of incentives.

Finally, from an environmental point of view, the situation in terms of CO₂ reintroduction into the atmosphere does not change: for a 1 MW plant, 3141 t/y of CO₂ are released directly into the atmosphere from the purification plant, while the remaining 4711 t/year of CO₂ are reintroduced into the atmosphere as a result of domestic use.

An alternative solution is the synthesis of liquid chemicals with a high added value, easily transportable and ready to use, starting from biogas.

Already known plants allow the formation of chemical products with a high added value starting from biogas, e.g. those described in WO2012/151545, WO2016/101076, GB2545474, which contemplate reforming to obtain syngas as intermediate product. In particular, the first and third of said prior art documents provide that syngas is obtained by carrying out steam reforming and partial oxidation (POX), whereas the second of said prior art documents contemplates an anhydrous reforming (dry reforming).

The second and third of these prior art documents provide that the plants described therein are used for the production of gasoline according to the Fischer Tropsch method, whereas the plants disclosed in the aforementioned prior document are intended for the production of methanol or dimethyl ether.

However, this latter document does not provide the replacement of some parts of the plant, nor the replacement of the synthesis section of the chemical product with a high added value to obtain a different one.

Moreover, even if the second prior document envisages that system parts can be replaced, such substitution is only designed to remove the exhausted catalyst, or remove obstructions etc., so it is designed to replace a section identical to the broken one, but it is certainly not intended for the preparation of chemical products other than those obtained before the replacement.

### SUMMARY OF THE INVENTION

The applicant has now found a plant that allows obtaining an easily transportable liquid chemical with a high added value and with a definitive CO₂ sequestration (negative impact). This happens through the non-invasive installation of an extremely flexible module, able to transform the biogas, usually in its entirety (CH₄ and CO₂), into the aforementioned desired final product.

An object of the present invention is therefore said plant for converting biogas into a chemical with a high added value selected among methanol, dimethyl ether, formaldehyde, acetic acid by a process comprising the following steps:

a) reforming by converting methane and carbon dioxide contained in the biogas into syngas,

b) synthesis of methanol by using syngas from step a),

b′) synthesis of one of the aforesaid chemical products: formaldehyde, dimethyl ether or acetic acid by using as a reagent methanol from step b),

c) optional purification and separation of said chemical product from step b) or b′), wherein

i) said plant is located downstream of the biogas production plant and consists of a compact module comprising:
section A), in which step a) is carried out, section B), in which step b) and step b′) are carried out, and an optional section C) in which step c) is carried out,
at least one section D) selected among least one of the following units: compression, lamination, heat exchange, Water Gas Shift (WGS), Pressure Swing Absorption (PSA), Solid Oxide Fuel Cells (SOFCs), burners, membranes, and medium pressure steam (MPS), said at least one section D) being arranged upstream or downstream of at least one of said sections A), B) and C),
and an automation/control section E),

ii) at least the whole section B) or a part thereof can be substituted with a further and different section B) or part of section B), to obtain one of the aforesaid chemical products different from the one obtained before said replacement of the whole section B) or part of it,

iii) said at least one section B) or part of section B) is connected to at least one adjacent section selected among: A), the optional C), and at least one of said sections D) by means of hydraulic connection devices.

The applicant has indeed found that, thanks to the process object of the invention, the following advantages are achieved:
a valid, sustainable, economically viable alternative to state incentives;
the production of chemical products with a high added value and degree of purity;
the possibility of reducing/eliminating the section C) for the purification of the module in which the process is carried out;
a high CO₂ abatement: the ⅔ of the total carbon fixed in CO₂ are not reintroduced into the atmosphere, but are fixed in the liquid chemical molecule. This does not apply if the chemical product with a high added value is used as a fuel (e.g. dimethyl ether, when it is used as a fuel in tractors, or gasoline obtained by the Fischer Tropsch synthesis); in this case, the impact approaches zero (like current biogas);
the module is easy to install. It is inserted downstream of the biogas plant and does not require any modification with respect to the one already existing in its non-energetically integrated forms;
the module used to carry out the process of the present invention offers a high production flexibility. The final product(s) may be changed at any time and with a minimal investment;
the module used to implement the process of the present invention is energetically self-sustainable;
without any incentive, it offers revenues at least equal to an incentivized biogas, revenues more than twice higher than those of an un-incentivized biogas, revenues about three times higher than those of an incentivized bio-methane and revenues ten times higher than those of an un-incentivized bio-methane.

### DESCRIPTION OF THE FIGURES

FIG. 1 shows a conceptual block diagram of the module or plant object of the invention and its downstream positioning with respect to the units of a conventional biogas preparation plant.

FIG. 2 shows the module or plant according to the present invention, in which the process of the invention is subdivided into the various sections A)-D), in which the chemical product bio-dimethyl ether is prepared, said product being easily convertible into a module to prepare (bio) acetic acid by replacing only one section, namely section B), where the bio-methyl ether synthesis takes place, with section B) where the bio-acetic acid synthesis takes place.

FIG. 3 shows in a schematized form the hydraulic-mechanical device of the valve/flange/valve type, which allows an easy connection or disconnection of a section to the neighbouring one(s) in the plant or module object of the present invention.

FIG. 4 describes the reforming section A) inserted inside the engine currently installed in the conventional biogas plant according to an important energy integration of the whole module according to the present invention, said integration being originated by the exchange of thermal waste between the engine currently installed in the conventional biogas plant and the aforementioned reforming section A).

FIG. 5 describes the feed-effluent technology, in which the energy for carrying out step a) in section A) (but also in the synthesis section B) of the module according to the present invention is recovered to pre-heat (or pre-cool) the feeding or the effluents.

FIG. 6 shows in a schematic form section B) of the plant according to the present invention for the synthesis of methanol, in which the methanol synthesis reactor is in stages with an optional partialization of the power supply.

FIG. 7 shows the layout of the system according to the present invention as described in Example 1.

FIG. 8 shows the integrated layout of a preferred form of the plant according to the present invention for preparing methanol as described in Example 1 to optimize its production and energy recovery.

FIG. 9 shows the layout of the plant according to the present invention for the synthesis of bio-dimethyl ether from biogas as described in Example 2.

FIG. 9b shows the layout of the plant according to the present invention for the synthesis of completely self-sustainable bio-dimethyl ether from an energy point of view.

FIG. 10 shows the process diagram for the preparation of acetic acid according to Option I, with a module with high power and heat generation for the self-sustainability of the same, as described in Example 3.

FIG. 11 shows the process diagram for the synthesis of acetic acid with a high recovery of CO₂, according to Option II, as described in Example 3.

FIG. 12 shows the process diagram for the synthesis of acetic acid according to Option III, with a module with high thermal efficiency.

FIG. 13 shows the Data Sheets of the process according to the present invention for preparing acetic acid according to Option III.

### DETAILED DESCRIPTION OF THE INVENTION

For the purposes of the present invention, the prefix bio before names of chemical products involved in the process of the present invention indicates that they have been obtained from biogas, but that their structure and chemical formula do not differ from the structure and chemical formula of the same compounds obtained by means of conventional industrial chemical processes.

The products obtainable with the plant object of the present invention are all hydrocarbon compounds with few carbon atoms and are selected among methanol, formaldehyde, acetic acid and dimethyl ether.

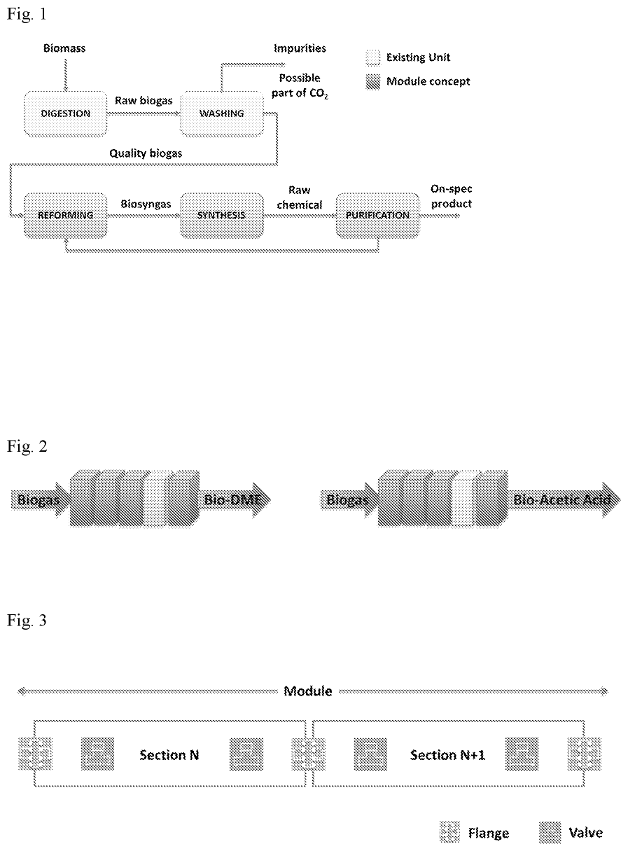

The module or plant object of the present invention preferably has dimensions 4 m×2 m×2 m and more preferably 4 m×1.5 m×1.5 m, namely dimensions such that the whole module or each section thereof can be easily transported by light means. This module is inserted downstream of the biogas plant as shown in FIG. 1. It is also characterized by the fact that the whole section B) can be replaced at any time with a minimum investment to vary the type of final chemical product depending on the market needs.

The purification section C) of the final product can be omitted or excluded from the plant object of the invention after upstream optimization of the feeding composition (e.g. by partial upstream removal of fed CO₂), or alternatively if no high purity is requested in the final product, e.g. in the case of non-stringent market requests or in the event that the end user has his/her own further purification process.

Therefore, each single section of said module has its own autonomy as regards temperature and pressure, even if integrated solutions are possible.

The modularity is guaranteed by hydraulic-mechanical devices.

Hydraulic-mechanical devices mean those devices that allow a rapid removal/replacement of one or more sections of said module to close the lines in which the fluids connecting a section and the neighbouring one(s) flow, and of the mechanical means allowing the attachment/detachment of this section to or from the neighbouring section(s). A connection of this type may e.g. be of the valve/flange/valve type, like the one shown in FIG. 3.

FIG. 2 shows, but is not limited to, a block diagram of the module in which the bio-dimethyl ether chemical product is produced according to the process of the present invention, in which only section (B) for the synthesis of bio-dimethyl ether is substituted with section B) for the synthesis of bio-acetic acid.

Each of said modules shown in FIG. 1 is for example made up of 5 sections, of which the first section starting from left to right is a heat exchange section (D), the second section is section A), followed by a further heat exchange section (D). The fourth section coloured with a different nuance is the synthesis section (B) for the production of dimethyl ether, which in the second configuration is substituted by the section (B) for the synthesis of acetic acid.

Since for the synthesis of dimethyl ether, formaldehyde and acetic acid, as discussed in detail in the following description, methanol is used as a reagent, the substitution of the whole section B) comprises both a part where the methanol synthesis is carried out starting from syngas and a second part where the desired product is synthesized.

For this reason it may be useful to replace only the portion of section B) for the production of the specific chemical product with a high added value through step b′). Therefore, in this case, the plant according to the present invention can provide that only the part of section B) used for the synthesis of the specific product is replaced.

In both cases, whether the whole section B) or only part of it is to be replaced, the plant object of the present invention is very versatile, since it allows producing a chemical product with a high added value able to satisfy not only the market requirements but also the local demand.

### SPECIFIC INFORMATION ON THE INDIVIDUAL SECTIONS (A), (B,) (C), (D) and E) OF THE MODULE

### Reforming Section

The reactions involved in the reforming are essentially three:

dry reforming or reaction (1)

CH₄+CO₂→2H₂+2CO (1)

steam reforming or reaction (2)

CH₄+H₂O→3H₂+CO (2)

and the balancing reaction (3) better known as water gas shift reaction (WGSR)

CO+H₂O [symbol] CO₂+H₂ (3)

The reforming operation implies a sharp increase in the number of moles and this is notoriously influenced by the pressure. Furthermore, a certain pressure allows reducing the volumes involved and ensures that the dimensions of section (A) are within the dimensions of the module in which the entire process of the invention is carried out.

A moderate pressure increase does not change, if not slightly, activity and selectivity of the main commercial catalysts. A pressure of 5-35 bar is preferable. More preferably, the pressure must be in a range of 10-20 bars; in this way, the certifications for operating the module do not change with respect to what is already required for the operation of the power generation engine currently installed on the plants. To facilitate the conversion of biogas into bio-syngas, the unit preferably operates in a temperature range of between 650-900° C., more preferably between 700-800° C., in the presence of platinum and rhodium catalysts and in accordance with the operating conditions of the engines currently installed on biogas plants. Furthermore, the use of steam hinders the formation of coke deposits on the catalysts and on their respective supports.

The reforming operation is endothermic. It must receive an enthalpic contribution to sustain itself and is usually coupled to a system of exothermic reactions (combustion or oxidation), or to energy sources of another nature (e.g. concentrated solar energy).

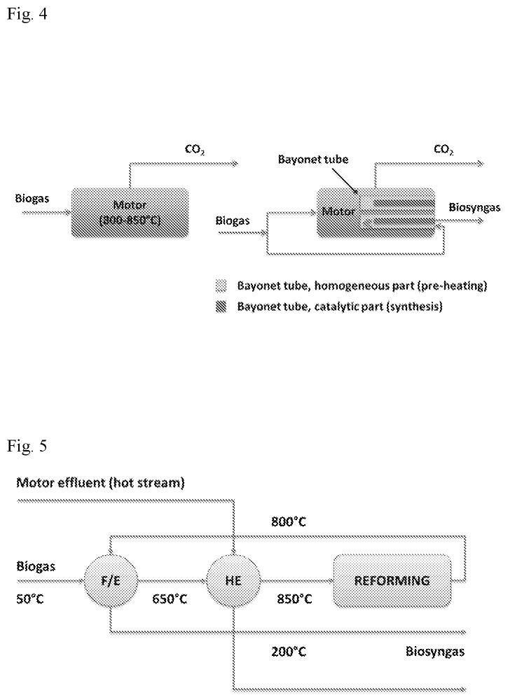

In the specific case, it is optionally provided a special apparatus that integrates the reforming section with the engine currently installed in the biogas plant, since their operating conditions are substantially identical, as shown for example in FIG. 4. A less invasive alternative of integration is represented by the exchange of thermal waste between the engine and the reforming section, possibly by means of a chamber external to the engine, which receives the hot fumes and transfers heat to the (preferably bayonet-shaped) tubes of the reforming. The feed-effluent technology, moreover, as for example shown in FIG. 5, allows reducing to the minimum this heat transfer thanks to the internal heat recovery from the reforming warm effluents.

### Methanol Synthesis Section (B)

The reactions involved in step b) carried out in section B) to obtain methanol are the following:

2H₂+CO→CH₃OH (4)

3H₂+CO₂→CH₃OH+H₂O (5)

CO+H₂O→CO₂+H₂ (6)

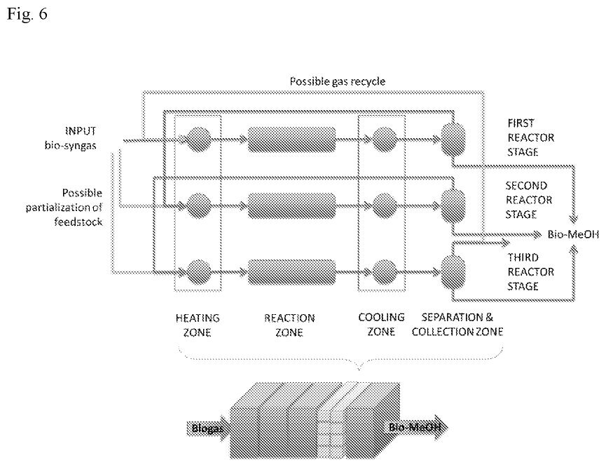

If the synthesis of interest is the one of methanol, it must be also considered the high exothermicity of the reaction. In this sense, it can also be optionally envisaged an energy integration between the reforming section (A) and the synthesis section (B). Moreover, it is essential considering the low methanol conversion in the single passage in the reactor (about 7% by volume). This involves large gas recycling and expensive recompression, typical of large plants. To improve this aspect and reduce it for the biogas sector, catalysts based on iron and copper oxides have been developed, capable of guaranteeing yields of 25-35% by volume for each passage in the reactor. Furthermore, to further reduce the gaseous recycles inside the module, the methanol synthesis reactor is in stages, with an optional partialization of the power supply exiting from the reforming section A) to heat in situ the stream to be fed at the various reaction steps B) (an implementation method that can be also extended to other products, such as DME). The reactor is schematized in FIG. 6. The biogas stream is (completely or partially) fed to a heater, enters a catalytic synthesis reactor and the effluent is then cooled before carrying out a phase separation. The heating can be carried out by partializing the stream coming out from the reformer in order to heat in situ the stream to be supplied to the various reaction steps. The cooling operation can be carried out by lamination, but more preferably by heat exchange.

### Acetic Acid Synthesis Section (B)

The overall reaction for the synthesis of acetic acid is as follows:

CH₃OH+CO→CH₃COOH (7)

The acetic acid synthesis process requires the carbonylation reaction of methanol. The standard process includes two reactors, catalytic tubular for methanol and slurry for acetic acid. The typical catalysts used for the synthesis of methanol are based on Cu—ZnO—Al₂O₃ or Cu—Zn—ZrO₂ in the presence of Ga₂O₃. The operating temperature and pressure conditions are of the order of 220-250° C. and 30-100 bar. In the case of biogas conversion, it is not optional to hypothesise such high pressures for reasons of safety, certification and regulations. Specific catalysts have therefore been developed with the same base as above, but in different concentrations, which are capable of favouring the synthesis of methanol at relatively low pressures, 10-40 bar, and preferably at 15-35 bar with high yields on the single passage in the reactor.

For the synthesis of acetic acid, commercial catalysts achieve conversions of methanol of 98% with high selectivity. All the results of the feasibility study are reported in the datasheet of FIG. 13 relative to Option III, as reported in Example 3 where the term by-products means a mixture of 25% dimethyl ether, 15% methyl formate, 55% methanol, 5% acetic anhydride.

### WGS Section D)

The WGS Section (D) is useful for correcting the H₂/CO ratio of syngas to favour some chemical synthesis, such as methanol or Fischer-Tropsch. Methanol requires an H₂/CO ratio of 2 (or slightly higher to avoid some parasitic reactions), since the reactions involved are the aforementioned reactions (1)-(3)

Only the first of the reactions is relevant to estimate the H₂/CO ratio, since the other two reactions are linearly dependent on it. Acetic acid requires an H₂/CO ratio of 1, since the overall reaction is the aforementioned reaction (7).

Similarly, formaldehyde, which is obtained with the reaction (8)

CH₃OH→CH₂O+H₂

requires a ratio of 1, considering that the process actually is a dehydrogenation of methanol.

The use of a WGS unit is often combined with a CO₂ removal system.

The WGS unit, however, becomes useless if the synthesis requires a ratio of H₂/CO equal to 1, because the methane is almost always the main compound of the biogas (over 50% by volume) and this allows having a H₂/CO ratio higher than 1. Any hydrogen surplus, if actually produced, can be fed to the generation engine.

### SOFCs Battery Section D)

SOFCs are one of the most useful systems for generating power in the event of a hydrogen surplus. They complete and energetically enrich the contribution of the module in cases of biogas with good level of methane and/or synthesis of chemical compounds that require low H₂/CO ratios.

### Medium-pressure Steam Batteries Section D)

Besides the compressors and the exchangers, the module where the process according to the present invention is carried out provides as further section D) also one or more heaters in which water is sent to generate medium-pressure steam, where a medium pressure means a range between 8 and 25 bars.

### Pressure Swing Absorption Unit Section D)

The module for carrying out the process according to the present invention can comprise one or more absorption swing adsorption columns for recovering hydrogen.

### Automation and Control Section E)

Wireless control systems are hypothesised for an internet connection, remotely or via cloud, for predictive performance management in order to guarantee a complete autonomy of the individual sections of the module, as well as to facilitate as much as possible their interchangeability.

Illustrative but non-limiting examples are given in which methanol, dimethyl ether and the production of acetic acid with three distinct versions of the energetically self-sustainable module are respectively obtained by means of the process of the invention.

### EXAMPLE 1

### Conversion of Biogas into Methanol

The module receives the biogas coming from the existing washing section, already installed on the currently operating plants for the removal of H₂S and other impurities. Biogas is fed to the first section of the module where the reforming operation takes place after compression, then passes into the synthesis section, where the syngas reacts to form methanol according to the reactions (1)-(3) above [Bozzano, Manenti, Efficient methanol synthesis: Perspectives, technologies and optimization strategies, Progress in Energy and Combustion Science, 56, 71-105, 2016. doi: 10.1016/j.pecs.2016.06.001]

The separation section recycles the unreacted syngas upstream of the reforming and removes the water by flash separation and membrane system.

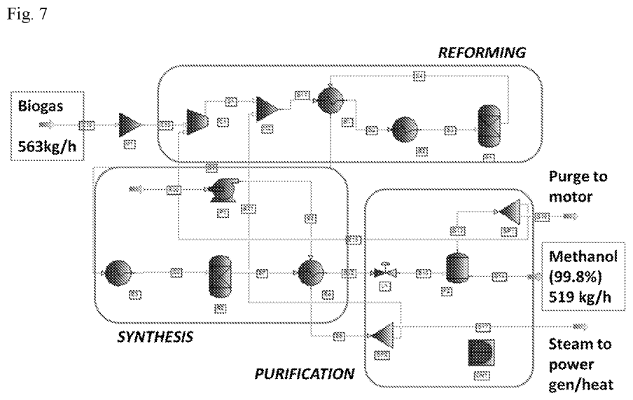

The diagram in FIG. 7 shows a process simulation with the help of PRO/II (Simsci-Esscor, Schneider-Electric), where the biogas coming from the washing (563 kg/h at 60% in methane for a 1 MW plant) is compressed, brought to temperature and fed to the reformer together with an appropriate amount of steam. In the reformer, methane is converted to about 95%. The effluents of the reformer are cooled in the feed/effluent gas-gas exchanger before entering the synthesis section. The synthesis of methanol requires three steps with an intermediate recovery and a total yield equal to 56.5% for the single passage. The yield is conservatively estimated based on the dedicated experiments carried out in the research group. The condensed liquid downstream of the synthesis is purified by flash separation (through unreacted bio-syngas recovery) and membrane (for water removal). 519 kg/h of 99.8% pure methanol are obtained.

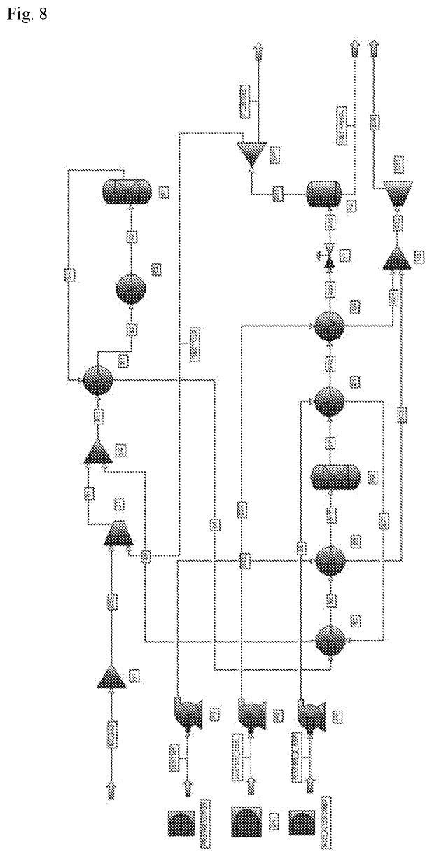

In a configuration optimized for energy recovery, the amount of methanol produced is even higher than the supplied biogas (FIG. 8). This is due to the fact that part of the steam used in the reforming unit is in turn converted into a product.

In the aforementioned figure optimized for energy recovery, the amount of produced methanol is even higher than the one of the supplied biogas. This is due to the fact that also part of the steam used in the reforming unit is converted into a product.

### EXAMPLE 2

### Conversion of Biogas into Dimethyl Ether

The synthesis section B) must be completely replaced to allow both the production of methanol as an intermediate product and its subsequent dehydration reaction according to the reaction (9).

CH₃OH→CH₃OCH₃+H₂O (8)

in the presence of catalysts already known for this type of reaction.

As an alternative to section B) of the methanol production plant as provided for in Example 1, only the portion of section B) dedicated to dehydration can be added as described in Example 2.

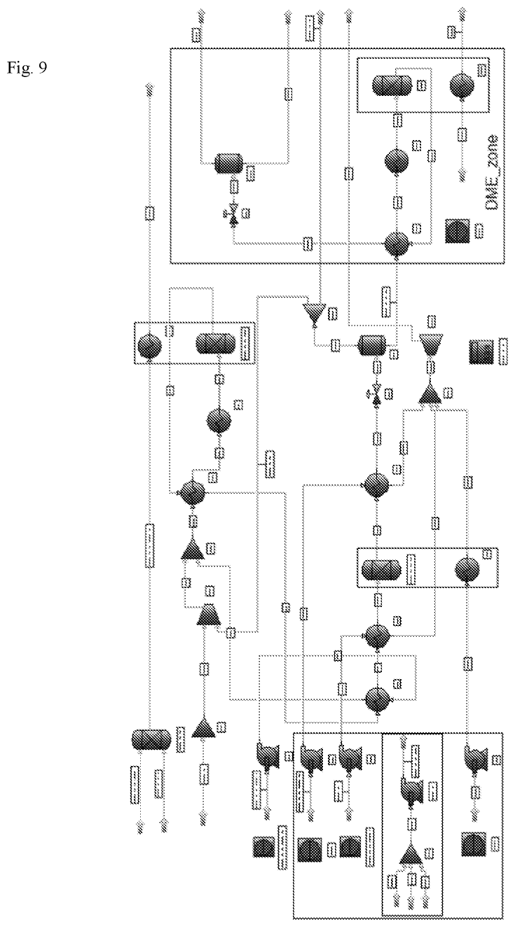

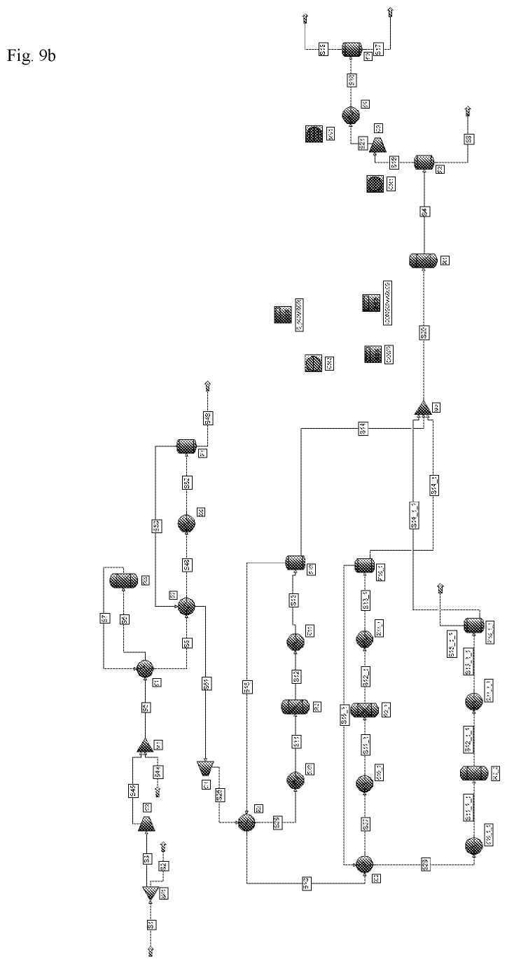

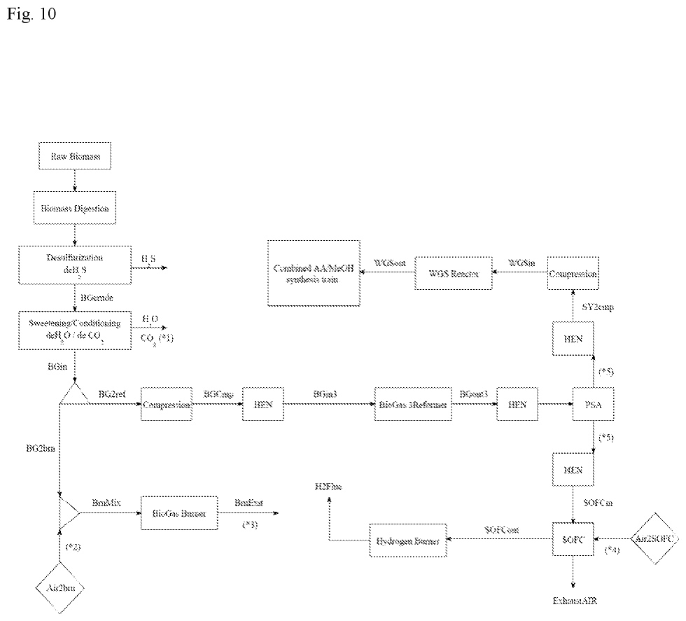

In the plant object of the invention and intended for the production of dimethyl ether, it is also useful to redesign the separation section, since the bio-DME appears less volatile. FIG. 9 shows a process layout for the synthesis of bio-DME from biogas with a double reaction and separation step to facilitate the production of a specific product.

With 563 kg/h of biogas fed to the module, 416 kg/h of specific bio-DME are obtained with a total yield of 75%. Considering that bio-DME is part of the new renewable and innovative fuels decree, the economic impact for this production is also significantly higher.

FIG. 9b shows a production scheme of a completely energetically self-sustainable bio-dimethyl ether. The module requires considerable energy to carry out the reforming (endothermic) reaction. Thanks to the use of a feed/effluent heat exchanger, this energy demand is reduced by 80-90%. The remaining energy (thermal) demand is sustained by a biogas percentage that is burned in the power generation engine, thus producing electricity as well as heat. Such energy sustainability, like most sustainability solutions, results in a net reduction of the production of chemical products, since part of the biogas is still burned in the power generation engine. However, in the case of FIG. 9b a part of biogas is still burnt, but only at the beginning of the processing to activate the module. In fact, when the module is completely switched on and operating, all biogas can be conveyed to the production and the residual gas that escapes from the module (mainly CH₄, CO₂, CO, H₂ and H₂O) is fed to the power generation engine. Typically installed engines accept this stream to generate electricity and heat. As a result, the module is energetically self-sustainable, after ignition with biogas, by thermally valorising its final effluents.

### EXAMPLE 3

### Conversion of Biogas into Acetic Acid According to Three Versions of the Energetically Self-Sustainable Module by Means of Ancillary Units

Three different layout modes for the synthesis module are shown. These modes also include additional units compared to what shown in FIG. 1. These additional units must provide the energy self-sustainability of the module, as well as optimize its performances.

Also in this case the synthesis section B) must be completely replaced to allow both the production of methanol as an intermediate product and its subsequent reaction (9) to give acetic acid.

As an alternative to the entire replacement of section B) of the methanol production plant as provided for in Example 1, only the portion of section B) dedicated to the formation of acetic acid can be added.

Option I

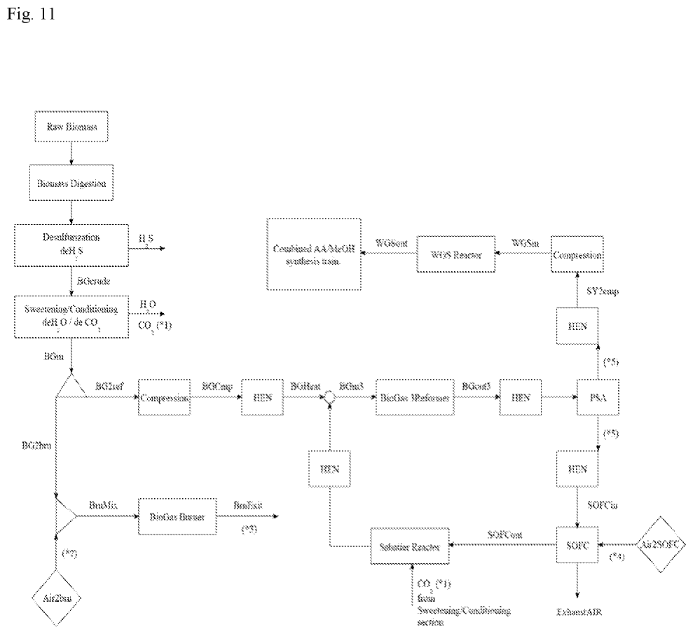

This alternative is shown in FIG. 11. The biogas coming from the washing is divided into two currents: the first is supplied to the reforming section, while the second is used as a fuel to support the reforming by heat exchange with a gas-gas exchanger. After heat exchange for energy recovery, the bio-syngas is sent to a Pressure Swing Absorption (PSA) unit for the recovery of hydrogen. Hydrogen is sent to a Solid Oxide Fuel Cells (SOFCs) battery for power generation, while the poor hydrogen stream is sent to the synthesis section, in this case for the production of acetic acid. If necessary, based on the CH₄/CO₂ ratio of the biogas, a Water Gas Shift (WGS) unit is also provided to obtain the optimal ratio required by the synthesis.

This solution exploits the combination of burners and SOFCs to have an adequate generation of electrical and thermal energy to meet the requirements of the module, as well as those of the farm where the biogas plant is installed.

Option II

This alternative is shown in FIG. 8. It differs from Option I because the eventual excess of hydrogen exiting the SOFC is supplied to a catalytic system of CO2 hydrogenation to reform methane.

The goal of this configuration is to maximize the recovery of CO2 by means of Sabatier-type hydrogenation systems.

Option III

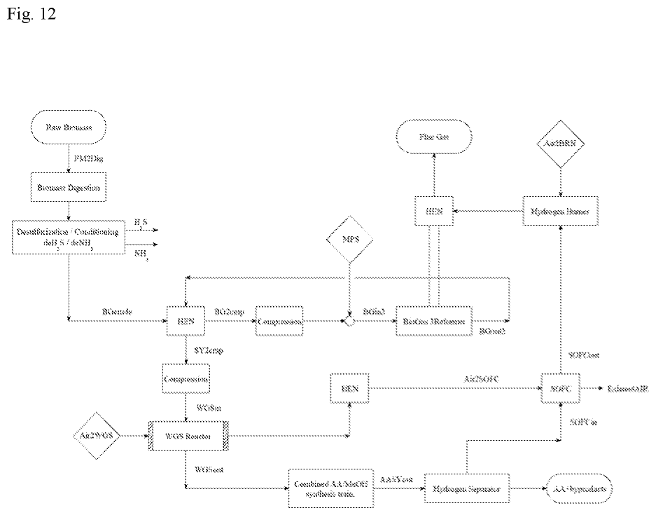

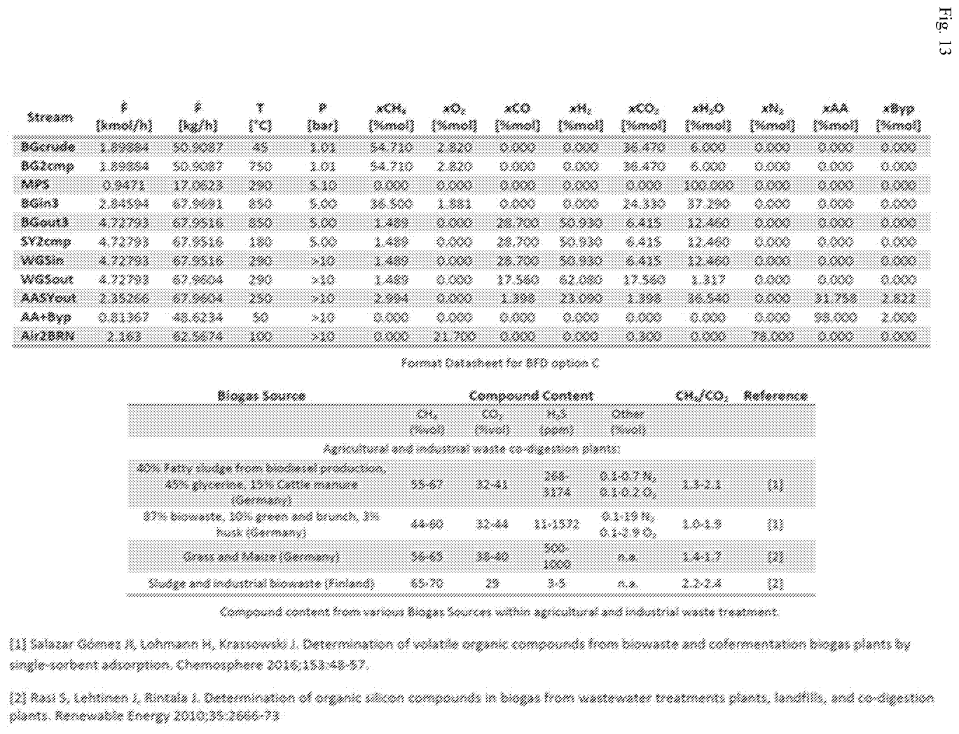

This alternative is shown in FIG. 12.

The biogas from the washing is fed to the reforming section together with a Medium Pressure Steam (MPS) stream. After heat exchange for energy recovery, the bio-syngas is fed to the acetid acid synthesis section.

This option aims at optimizing the thermal efficiency of the process and at the same time minimizing the process units involved. For this specific case, data sheets are reported.

In all the above cases, the burners can be replaced by the currently installed engine. The following table offers a comparison of the various options compared to the current biogas plant.

| Alternative | Advantages | Disadvantages |
|---|---|---|
| I | Production of energy in an | Lower production of |
| | almost adiabatic system of | acetic acid due to the |
| | reforming and combustion | splitting of the biogas |
| | units. | entering the reforming |
| | High sequestration of | units |
| | carbon by checking the | Operating limits with the |
| | composition entering the | PSA unit, thus requiring |
| | synthesis unit | more complex heat |
| | | exchange networks |
| | | Large number of gas-gas |
| | | heat exchangers that |
| | | negatively and strongly |
| | | influence the investment |
| | | costs |
| II | Production of energy in an | Operating limits with the |
| | almost adiabatic system of | PSA units requiring more |
| | reforming and combustion | complex heat exchange |
| | units. | networks |
| | High sequestration of | Large number of gas-gas |
| | carbon by checking the | heat exchangers that |
| | composition entering the | negatively and strongly |
| | synthesis unit | influence the investment |
| | Recycling of unreacted | costs |
| | hydrogen and methane | Insufficient control over |
| | Partial water demand | the operating conditions |
| | | of the Sabatier reactor |
| III | Reduced number of | Lower energy production |
| | operating units and | (even absent with no |
| | consequently lower fixed | SOFCs, which is however |
| | costs with respect to the | a feasible alternative) |
| | other two alternatives | Partial energy demand to |
| | Good control of the same | operate the reformer |
| | thanks to the absence of | section |
| | recycling (high potential | |
| | intensification) | |
| | The highest sequestration | |
| | of carbon and fixing | |
| | The highest thermal | |
| | efficiency | |
| Conventional | Energy production | CO₂ sequestration is |
| biogas plant | enhanced by the particular | absent, or at least a CCS |
| | type of power supply | units captures and |
| | So-called carbon closed | sequestrates carbon when |
| | loop cycle by natural | increasing the content of |
| | feeding | bio-methane (biogas |
| | | upgrading) |
| | | Not economically feasible |
| | | without government |
| | | incentives. |

It is reported for illustrative but non-limiting purposes the economic effects of the process according to the present invention, in particular for the synthesis of acetic acid according to Option III compared with conventional biogas plants used for the production of electricity.

Starting from 20 kg/h of wet biogas with a CH_{4/}CO₂ ratio of 1.5, 13.88 kg/h of dry biogas are obtained (equivalent to 11.43 Nm3/h). The equivalent power generated by this amount is equal to 27.7 kW, starting from the assumption that the main generation efficiency is 40%. With the same equivalent energy potential, the process object of the present invention guarantees an income (not incentivized) comparable to what is perceived with the incentivized biogas:

Revenues

| | | | No | | | CO₂ |
|---|---|---|---|---|---|---|
| | Power | Operations | incentive | | Incentive | impact |
| Plant in use | 1000 kW | 8000 h/year | 0.88 | M€ | 1.84 M€ | 0% |
| Option III | 1000 kW | 8000 h/year | 1.8-2.2 | M€ | — | −65% |

| | |
|---|---|
| Power | 1 MW-scale |
| Volumetric flow (anhydrous conditions) | 420.26 Nm3/h |
| Annual power production | 8000 MWh/year |
| Annual power production | 4080 ton/year |
| Estimated revenue | 2.04 M€/year |

1-19. (canceled)

20. A plant for converting biogas into a chemical product with a high added value selected among methanol, dimethyl ether, formaldehyde and acetic acid, said plant being located downstream of the biogas production plant and consisting of a compact module comprising:
a reforming section A), in which methane and carbon dioxide contained in the biogas are converted into syngas (step a),
a section B), comprising
a first part in which syngas coming from section A) is converted into methanol (step b)
an optional second part wherein methanol coming from said first part is optionally converted into one of said chemical products with a high added value selected among methanol, dimethyl ether, formaldehyde and acetic acid (step b′)
an optional section C), in which the product coming from section B) is optionally purified and separated according to step b);
at least one section D) selected among at least one of the following units:
compression, lamination, heat exchange, Water Gas Shift (WGS), Pressure Swing Absorption (PSA), Solid Oxide Fuel Cells (SOFCs), burners, membranes, and medium pressure steam (MPS), said at least one section D) being arranged upstream or downstream of at least one of said sections A), B) and C),
and an automation/control section E),
wherein
i) at least the whole section B) or said second part thereof can be respectively substituted with a different whole section B) or at least said second part of section B) to obtain one of the aforesaid chemical products different from the one obtained before said replacement of the whole section B) or said second part of section B),
ii) said at least whole section B) or said second part of section B) is connected to at least one adjacent section selected among: A), the optional C), and at least one of said sections D), by means of hydraulic connection devices of the valve/flange/valve type.

21. The plant according to claim 20, having volumetric dimensions 4 meters (m)×2 m×2 m.

22. The plant according to claim 20, wherein
the reforming reaction a) is carried out in the section A) of the module according to the following reactions scheme:
CH₄+CO₂→2H₂+2CO (1)
CH₄+H₂O→3H₂+CO (2)
and the balancing reaction (3), better known as water gas shift reaction (WGS)
CO+H₂O [symbol] CO₂+H₂ (3)
is carried out at pressure between 5 bar and 35 bar, at temperature between 650° C. and 900° C., in the presence of platinum and rhodium catalysts, cerium catalysts, or cerium and lanthanum catalysts.

23. The plant according to claim 22, wherein the reforming section is integrated with the engine currently installed in the conventional biogas plant.

24. The plant according to claim 22, wherein the energy required to carry out the reforming reaction is provided by the thermal waste produced by the engine and/or by the reforming section through the feed-effluent technology or by the use of the effluents of the plant as engine supply.

25. The plant according to claim 20, wherein when the chemical product is methanol, step b) is carried out in section B) according to the following reactions:
2H₂+CO→CH₃OH (4)
3H₂+CO₂→CH₃OH+H₂O (5)
CO+H₂O→CO₂+H₂ (6)
in the presence of iron and copper oxide catalysts.

26. The plant according to claim 25, wherein section B), is a stage reactor.

27. The plant according to claim 25, wherein the biogas from the washing section of the biogas production plants, partially compressed in the compression section D), is fed to the first section of the module A), where the reforming occurs, then passes into the synthesis section B), where the syngas reacts to form methanol according to the reactions (4) to (6), and finally passes into the optional section C) wherein:
methanol is separated;
unreacted syngas is recycled and sent upstream of the reforming section A); and
water is removed by flash separation and/or membrane system.

28. The plant according to claim 25, wherein when the chemical product with a high added value is dimethyl ether, step b′) is carried out according to the following reaction:
CH₃OH→CH₃OCH₃+H₂O (9)
and the section B) comprising said second part wherein said reaction (9) is carried out, and said second part is a double-step reactor with intermediate separation.

29. The plant according to claim 25, wherein when the product with a high added value is acetic acid, step b′) is carried out according to the following reaction:
CH₃OH+CO→CH₃COOH (7)
in the presence of Cu—ZnO—Al₂O₃ or Cu—Zn—ZrO₂ catalysts in the presence of Ga₂O₃ at pressure between 10 bar and 40 bar, and section B) comprises said second part wherein said reaction (7) is carried out.

30. The plant according to claim 29, wherein:
the biogas from the washing section is divided into two streams: the first is supplied to the reforming section A), whereas the second is used as a fuel to generate power and thermally sustain the reforming in the heat exchange section D) by means of a gas-gas or of a firebox exchanger;
after the heat exchange for energy recovery, the bio-syngas is sent to another section D) consisting of a Pressure Swing Absorption (PSA) battery for hydrogen recovery;
hydrogen is then sent to another section D) consisting of Solid Oxide Fuel Cells (SOFCs) battery for generating power, whereas the poor hydrogen stream is sent to the synthesis section B), in this case for the production of acetic acid.

31. The plant according to claim 30, further comprising:
a section D) consisting of a Water Gas Shift (WGS) unit for obtaining the optimal ratio required for acetic acid synthesis.

32. The plant according to claim 30, wherein any hydrogen excess released from the SOFCs is supplied to a catalytic hydrogenation system of CO₂ to reform methane.

33. The plant according to claim 29, wherein:
the biogas from the washing section is supplied to the reforming section along with a medium pressure steam stream from the Medium Pressure Steam (MPS) section D); and
after the heat exchange occurring in the corresponding energy recovery section D), the bio-syngas is sent to the acetic acid synthesis section B).

34. The plant according to claim 29, wherein the heaters section D) is replaced by the engine installed in conventional biogas plants.

35. The plant according to claim 25, wherein when the chemical product with a high added value is formaldehyde, it is carried out in section B) and step b′) is carried out according to the following reaction (8)
CH₃OH→CH₂O+H₂. (8)

36. The plant according to claim 20, having volumetric dimensions 4 meters (m)×1.5 m×1.5 m.

37. The plant according to claim 20, wherein
the reforming reaction a) is carried out in the section A) of the module according to the following reactions scheme:
CH₄+CO₂→2H₂+2CO (1)
CH₄+H₂O→3H₂+CO (2)
and the balancing reaction (3), better known as water gas shift reaction (WGS)
CO+H₂O [symbol] CO₂+H₂ (3)
is carried out at pressure between 5 bar and 35 bar, at temperature between 700° C. and 800° C., in the presence of platinum and rhodium catalysts, cerium catalysts, or cerium and lanthanum catalysts.
reactor with intermediate separation.

38. The plant according to claim 20, wherein
the reforming reaction a) is carried out in the section A) of the module according to the following reactions scheme:
CH₄+CO₂→2H₂+2CO (1)
CH₄+H₂O→3H₂+CO (2)
and the balancing reaction (3), better known as water gas shift reaction (WGS)
CO+H₂O [symbol] CO₂+H₂ (3)
is carried out at pressure between 10 bar and 20 bar, at temperature between 700° C. and 800° C., in the presence of platinum and rhodium catalysts, cerium catalysts, or cerium and lanthanum catalysts.
reactor with intermediate separation.

39. The plant according to claim 25, wherein when the product with a high added value is acetic acid, step b′) is carried out according to the following reaction:
CH₃OH+CO→CH₃COOH (7)
in the presence of Cu—ZnO—Al₂O₃ or Cu—Zn—ZrO₂ catalysts in the presence of Ga₂O₃ at pressure between 10 bar and 20 bar, and section B) comprises said second part wherein said reaction (7) is carried out.
